(19) United States
(12) Patent Application Publication
(10) Pub. No.: US 2016/0378877 A1
(43) Pub. Date: Dec. 29, 2016

(54) SYSTEM AND METHOD FOR RECOVERING LOST ITEMS

(71) Applicant: Vishal Khemka, Arlington, VA (US)

(72) Inventor: Vishal Khemka, Arlington, VA (US)

(21) Appl. No.: 15/154,833

(22) Filed: May 13, 2016

Related U.S. Application Data
(60) Provisional application No. 62/160,600, filed on May 13, 2015.

(51) Int. Cl. G06F 17/30; G06K 19/06

(52) U.S. Cl. CPC G06F 17/30876; G06K 19/06037; G06K 19/06028

(57) ABSTRACT

A method of recovering a lost item belonging to a first user which includes obtaining a unique label having item identification data displayed on a first surface and an adhesive layer on an opposing second surface, affixing the unique label onto an item belonging to a first user, inputting first user identification information and the item identification data displayed on the unique label into a database, and receiving an alert when item identification data inputted by a second user into the database matches the item identification data corresponding to the item belonging to the first user.

### CROSS-REFERENCE TO RELATED APPLICATIONS

This application claims the benefit of U.S. Provisional Patent Application No. 62/140,600, filed on May 13, 2015, the disclosure of which is incorporated herein in its entirety by reference.

### BACKGROUND OF THE INVENTION:

1. Field of the Invention

The present general inventive concept relates to a system and method for recovering lost items, and more particularly, to a method of using a unique identification label placed on an item and a central database having the unique identification label registered therein to identify an owner of the lost item.

2. Description of Related Art

Each year many people around the world misplace all types of items, costing them thousands of dollars to replace. Some places even have designated lost and found areas, where items may be turned in by good Samaritans in hopes that the owner returns to claim it. However, since many people have no idea about designated lost and found areas or where they would have to go to recover their misplaced items, many items remain unclaimed. Therefore, these designated lost and found areas are not always effective in locating the owners of lost items and returning the lost items.

In some cases, there are good Samaritans who find lost items and wish to return the item to its owner, however they are also unaware of the designated lost and find areas or do not want to take the extra trouble of locating one. Some items may have a Bluetooth™ tag to help the owner locate the misplaced item but the owner would be need to be within a close proximity of the lost item. The Bluetooth™ tag is also quite expensive and requires a lengthy process to pair with a mobile device to notify the owner.

Therefore, what is needed is a cost effective virtual lost and found system which allows finders of lost items to easily notify rightful owners of the lost items.

### SUMMARY OF THE INVENTION

The present general inventive concept provides a system and method for recovering lost or discovered items, and more particularly, to a method of using a unique identification label, tag, or other type identification device placed on an item and a central application system to identify and/or communicate to an owner of the discovered item.

The present general inventive concept provides a method for recovering lost items which includes providing a web site (e.g., www.findowner.me) which is accessible through the Internet and affixing a unique label or tag to an owner's (i.e., a first user) item. The method further includes the first user receiving a notification from a second user who found or discovered the item belonging to the first user. The second user may then follow simple instructions displayed on the unique label to input and/or scan the unique number, barcode, and/or QR code on the label using an application (e.g., a mobile application) executed on a mobile device such as the FindOwner mobile application or a website, such as the FindOwner web site. The mobile application or the website may communicate with a central application system or database which stores the unique label numbers, barcodes, and/or QR codes displayed on the unique label and the corresponding owner of the item to which the unique label is associated to.

The system and method for recovering lost or discovered items according to the present general inventive concept provides a method for a good Samaritan (i.e., a second user) to safely identify and communicate with the rightful owner of a found item, thereby increasing a likelihood of the owner recovering his or her lost items.

The foregoing and/or other aspects of the present general inventive concept may be achieved by providing a method of recovering a lost item belonging to a first user which includes obtaining a unique label having item identification data displayed on a first surface and an adhesive layer on an opposing second surface, affixing the unique label onto an item belonging to a first user, registering an account by inputting first user identification information and the item identification data displayed on the unique label into a central application system, and receiving an alert when item identification data inputted by a second user into the central application system matches the item identification data registered to the account corresponding to the first user.

The unique label further includes item return instructions while safeguarding the item owner's actual contact information.

The item identification data may include a barcode or a QR code.

The method may further include registering an account to a web site using the first user identification information.

At least one of the first user identification information and the item identification data displayed on the unique label may be inputted into the database using a first mobile device.

The item identification data may include a barcode or a QR code corresponding to the item belonging to the first user.

The first mobile device may include an image capturing device to read the barcode or the QR code of the item identification data.

The method may further include using the first mobile device to capture an image of the item belonging to the first user and inputting the captured image to the central application system.

When an item is lost, the first user is provided the option to mark the item as lost and may consent to sharing the first user contact information with whomever finds the lost item. The first user may then use the mobile application or the website to indicate or mark the item as being lost or misplaced.

The method may further include inputting into the central application system a reward for returning the lost item back to the first user.

The method may further include inputting into the central application system a phone number or other contact information of the first user in order to return the lost item back to the first user. In an example embodiment, as a default, the phone number from the user account profile is pre-populated. The first user may then choose to change the phone number or other contact information to a different alternative phone number or contact information. For example, if the item the user lost was his mobile phone, the user may login to his user account profile and provide an alternative contact number so that the finder of his mobile phone may contact the first user. The alternative number may include temporary contact numbers such as a hotel or temporary housing contact information which may be used by the first user while traveling.

When the lost item is found by the second user, the second user may input the item identification data displayed on the unique label into the central application system by using a second mobile device.

The first user may indicate within the mobile application or the website whether or not a reward will be given to the finder who returns the lost item to the first user. If the first user indicated that a reward would be given, the second user is sent a message specifying the reward amount. The finder (i.e., the second user) will need to provide his or her contact information, such as an email address and/or telephone number, and provide a message to be sent to the first user. At the same time, an image of the lost item and the location co-ordinates of the lost item may be sent to the owner to verify that the item is his and is in acceptable condition.

If the first user's item is not marked as lost, the first user would receive a notification message that a second user has located an item that has been registered to him or her. Once the first user verifies that the item is in fact lost, the first user (i.e., the owner) may then indicate that the item is lost and consents to sharing his actual contact information with the second user (i.e., the finder).

The central application system facilitates communication and exchanges of contact information between the owner and the finder.

The owner or finder may then communicate with each other in order to co-ordinate and return the lost item to the owner. On recovering the lost item the owner rewards the finder if a reward was announced when the item was marked as lost.

Additional aspects of the present general inventive concept will be set forth in part in the description which follows and, in part, will be obvious from the description, or may be learned by practice of the general inventive concept.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 illustrates a schematic block diagram illustrating a system for recovering lost items according to an example embodiment of the present general inventive concept;

FIG. 2 is a diagram of a unique label used with the system illustrated in FIG. 1;

FIG. 3 illustrates a flow chart showing a method for recovering lost items according to an example embodiment of the present general inventive concept;

FIG. 4A illustrates a flow chart showing a method for recovering lost items according to another example embodiment of the present general inventive concept;

FIG. 4B illustrates a flow chart showing a method for recovering lost items according to yet another example embodiment of the present general inventive concept; and

FIGS. 5A-5G illustrates graphical user interface (GUI) of a mobile application implementing a method for recovering lost items according to an example embodiment of the present general inventive concept.

### DETAILED DESCRIPTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

The present general inventive concept provides a system including a web site (e.g., www.findowner.me) accessible through the Internet and a unique label or tag affixed to an owner's (i.e., a first user) item which may be used by a good Samaritan (i.e., a second user) to identify, locate, and/or communicate with first user to help return the lost item back to the first user. However, the present general inventive concept is not limited thereto.

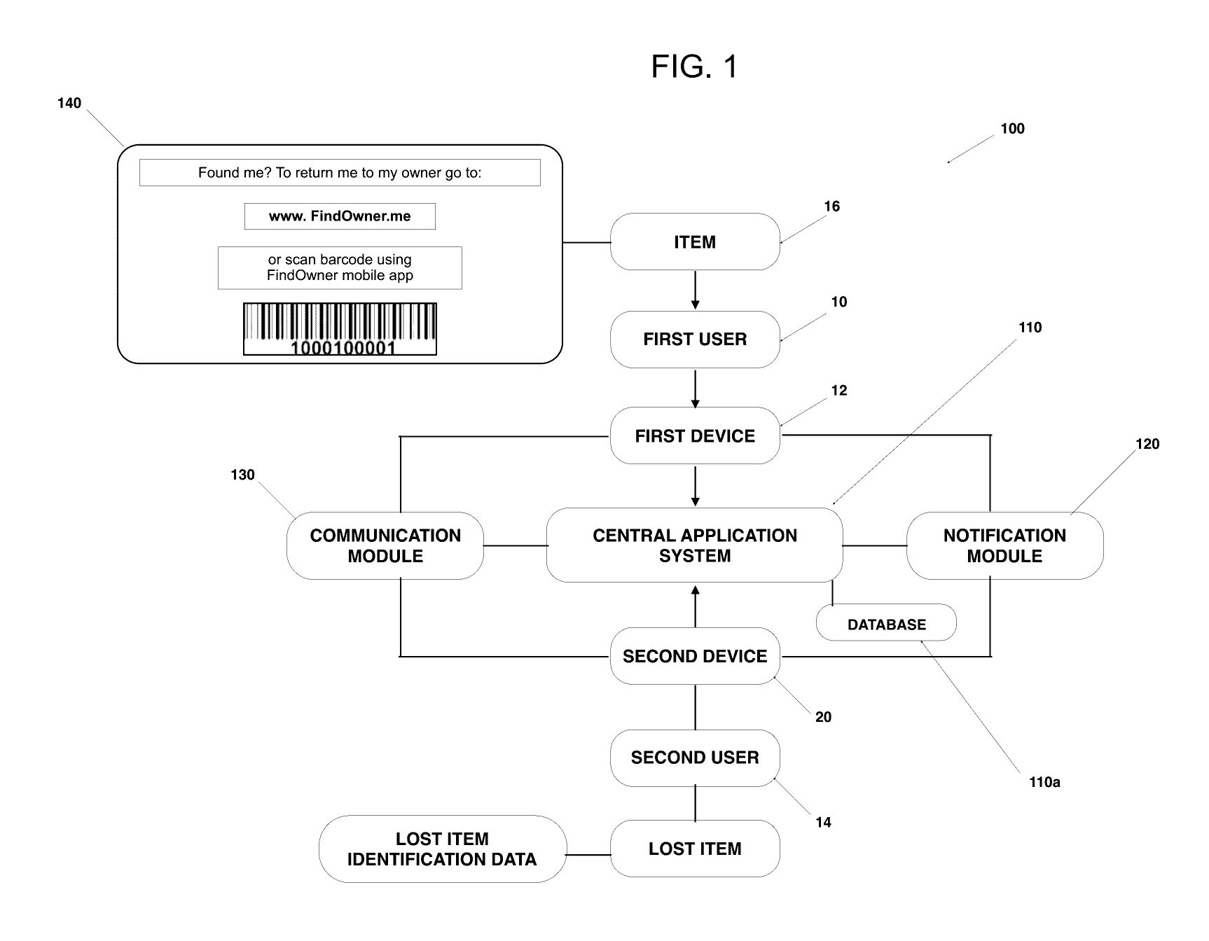

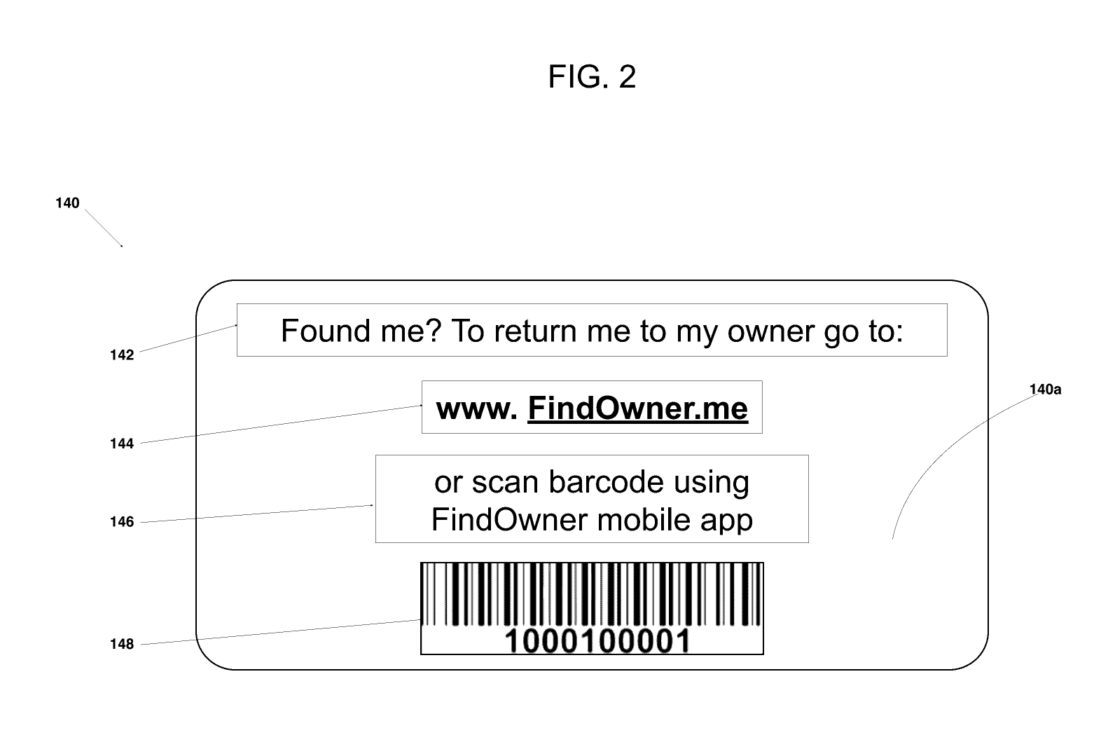

FIG. 1 illustrates a schematic block diagram illustrating a system 100 for recovering lost items according to an example embodiment of the present general inventive concept. FIG. 2 is a diagram of a unique label 140 used with the system illustrated in FIG. 1.

Referring to FIG. 1, the system 100 for recovering lost items according to the present general inventive concept includes a central application system 110 which is in communication with a database 110a, a notification module 120 and a communication module 130, and a unique label 140 affixed to an item. The central application system 110 may be accessible by a first user 10 using a first device 12. Similarly, the central application system 110 may also be accessible by a second user 20 using a second device 14. That is, the first and second devices 12 and 14 may be used to access and/or communicate with the central application system 110 via the Internet or various other networking means.

In the present example embodiment, in operation, the first user 10 may initially affix a unique label 140 onto an item 16. The unique label 140 may include a first surface 140a and an opposing second surface 140b. The unique label 140 may further include a plurality of data fields displayed on the first surface 140a and an adhesive layer affixed to the second surface 140b (not illustrated).

The plurality of data fields may include a finder instruction field 142 which provides instructions to a second user 20 (e.g., a good Samaritan) on how to return the item 16 to the first user 10, an address field 144 which provides a website address (e.g., www.findowner.me) accessible over the Internet which may be used to access the central application system 110, and an input instruction field 146 which provides instructions on how to access the central application system 110 and which information on the unique label 140 is required to be entered into the central application system 110. In addition, the unique label 140 further includes a unique item identification data field 148 which includes, represents, and/or displays unique data (e.g., barcode or QR code) for each unique label 140.

In the present example embodiment, the item identification data field 148 may include a unique barcode or QR code corresponding to the item 16 belonging to the first user 10. However, the present general inventive concept is not limited thereto. That is, in alternative example embodiments, the item identification data field 148 may utilize information such as a model number and/or a serial number assigned by a manufacturer of the item 12 and placed on a manufacturer's label. For example, a barcode or serial number of a mobile phone may be used as the unique item identification data displayed on the item 12 which may be used to identify each item belonging to the first owner 10 within the central application system 110.

In alternative example embodiments, the unique label 140 may be supplied to the manufacturer and/or distributor of items. The first owner 10 purchasing such items will be then required to input the item identification data displayed on the unique label 140 into an account in the central application system 110 corresponding to the first user 10.

In the present example embodiment, when the second user 20 (i.e., the good Samaritan) discovers the item 16 belonging to the first user 10. The second user 20 may easily locate the owner of the item 16 and securely communicate with the first user 10 in order to coordinate a safe return of the item 16 to the first user 10 by following the instructions displayed on the unique label 140.

The second user 20 may then use the second device 14 (e.g., a mobile device or computer) to scan the unique identifier on the unique label 140 or navigate to the website address displayed within the address field 144 (e.g., www.findowner.me) of the unique label 140 in order to access the central application system 110 through the Internet or in a cloud. The second user 20 may then be instructed by the system 100 to input the item identification data displayed in the unique item identification data field 148 of the unique label 140 attached to the found item 16.

As such, when the item identification data inputted by the second user 20 corresponds to or matches the item identification data previously registered to the first user 10 within the central application system 110, the system 100 then instructs the notification module 120 to send an alert or notification message to the first user 10.

The notification message would notify the first user 10 that an item 16 registered to him was lost and now has been found by the second user 20. The first user 10 may then choose to indicate a desire to securely communicate with the second user 20 through the central application system 110. The system 100 may then instruct the communication module 130 to allow secured communication between the first user 10 and the second user 20. However, the present general inventive concept is not limited thereto.

In the present example embodiment, secured communication refers to safeguarding the first user's 10 contact information from the second user 20. As a result, the first user 10 may securely communicate with the second user 20 in order to coordinate a safe recovery of the item 16.

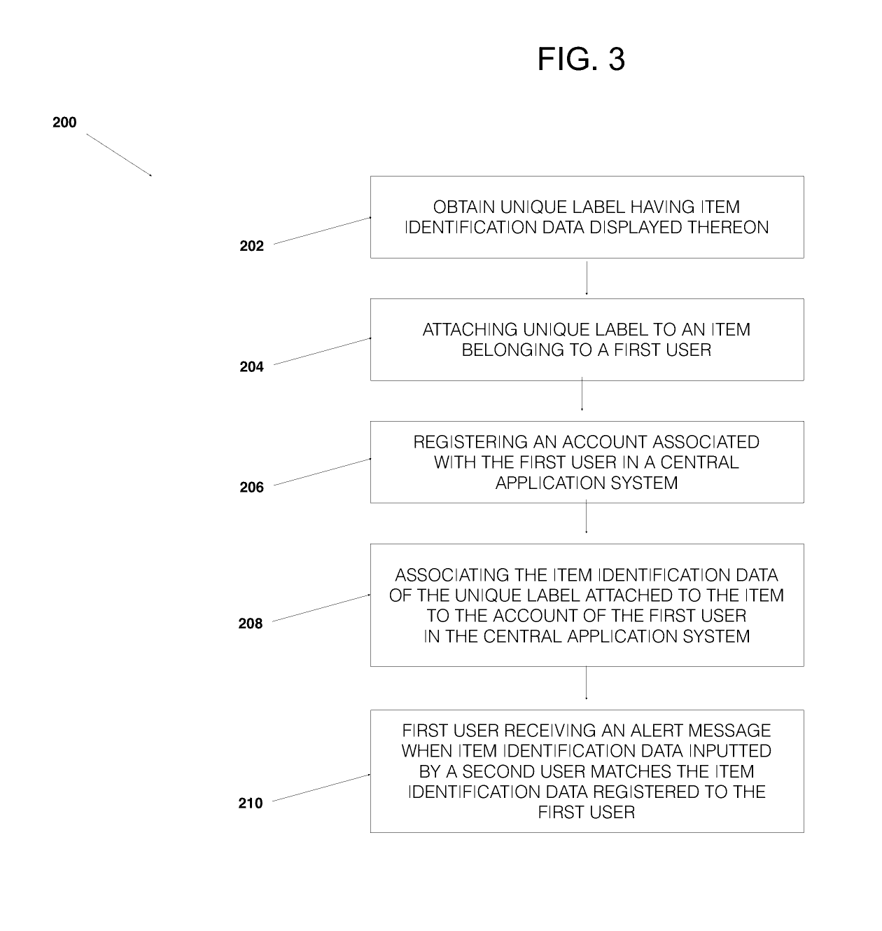

FIG. 3 illustrates a flow chart showing a method 200 for recovering lost items according to an example embodiment of the present general inventive concept.

Referring to FIG. 3, the method 200 for recovering lost items belonging to a first user 10 includes the following steps.

At step 202, the method 200 includes obtaining a unique label 140 having item identification data 148 (i.e., first item identification data) displayed on a first surface 140a and an adhesive layer 140b (not illustrated) on an opposing second surface 140b. However, the present general inventive concept is not limited thereto. That is, in alternative example embodiments, the unique label 140 may include various other non-electronic and electronic tags including RFID tags, near field communication devices, or the like. The item identification data 148 may include a barcode, a QR code, or various other unique patterns to uniquely identify that specific label or tag. For instance, various types of near field communication (NFC) may be used as the unique label. However, the present general inventive concept is not limited thereto.

NFC refers to a wireless technology which allows for the transfer of data such as text or numbers between two NFC enabled devices. NFC tags, for example stickers or wristbands, contain small microchips with little aerials which can store a small amount of information for transfer to another NFC device, such as a mobile phone.

At step 204, the unique label 140, electronic tag, RFID, NFC, or like device may then be affixed to an item belonging to a first user 10.

At step 206, the first user 10 may register an account with a central application system 110 which may include a database 110a that is used to store item identification data 148 and corresponding user identification information of the owner or user (e.g., actual contact information of the first user).

At step 208, the first user 10 may input the item identification data displayed on the unique label 140, and a description along with an image of the item 16 into the central application system 110. The central application system 110 may then store all registered items having a unique label 140 associated therewith into the database 110a. However, the present general inventive concept is not limited thereto. That is, in alternative example embodiments, the central application system 110 may store data within a cloud environment.

At step 210, the first user 10 may receive an alert message or other type of notification from the central application system 110, when an item registered to the first user 10 has been located and the corresponding item identification data 148 has been inputted into the central application system 110.

That is, in the present example embodiment, after a second user 20 (i.e., a good Samaritan) finds a lost or misplaced item, the second user 20 navigates to a web site having access to the central application system 110 and then inputs an item identification data displayed on a unique label 140 attached to the item. When the item identification data 12 inputted by the second user 20 is found within the database 110a or cloud environment, the central application system 110 alerts the owner that his item has been located. In this case, if the item identification data inputted by the second user 20 is found in the database 110a, the central application system 110 then sends an alert message to the first user 10 that his item 16 has been found.

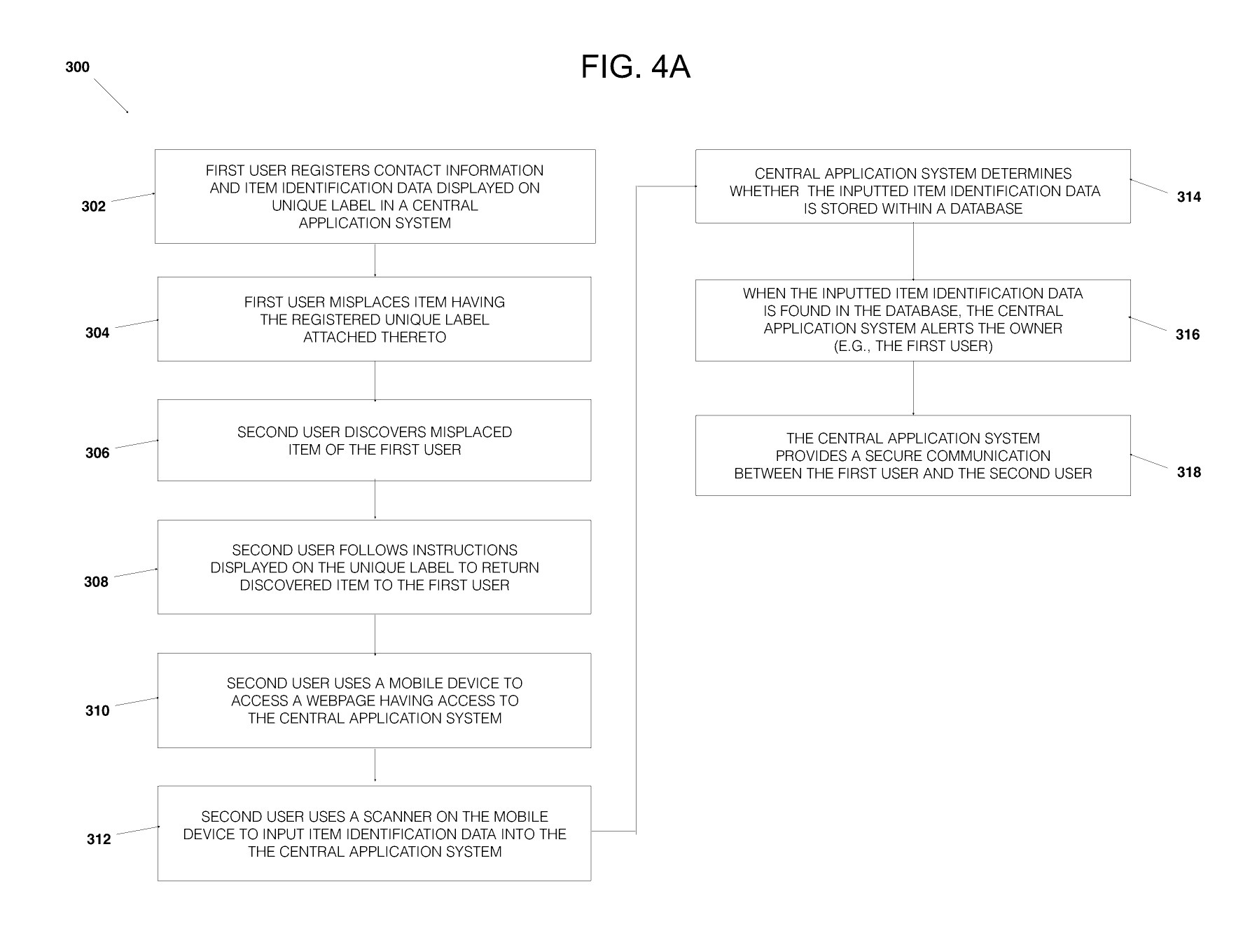

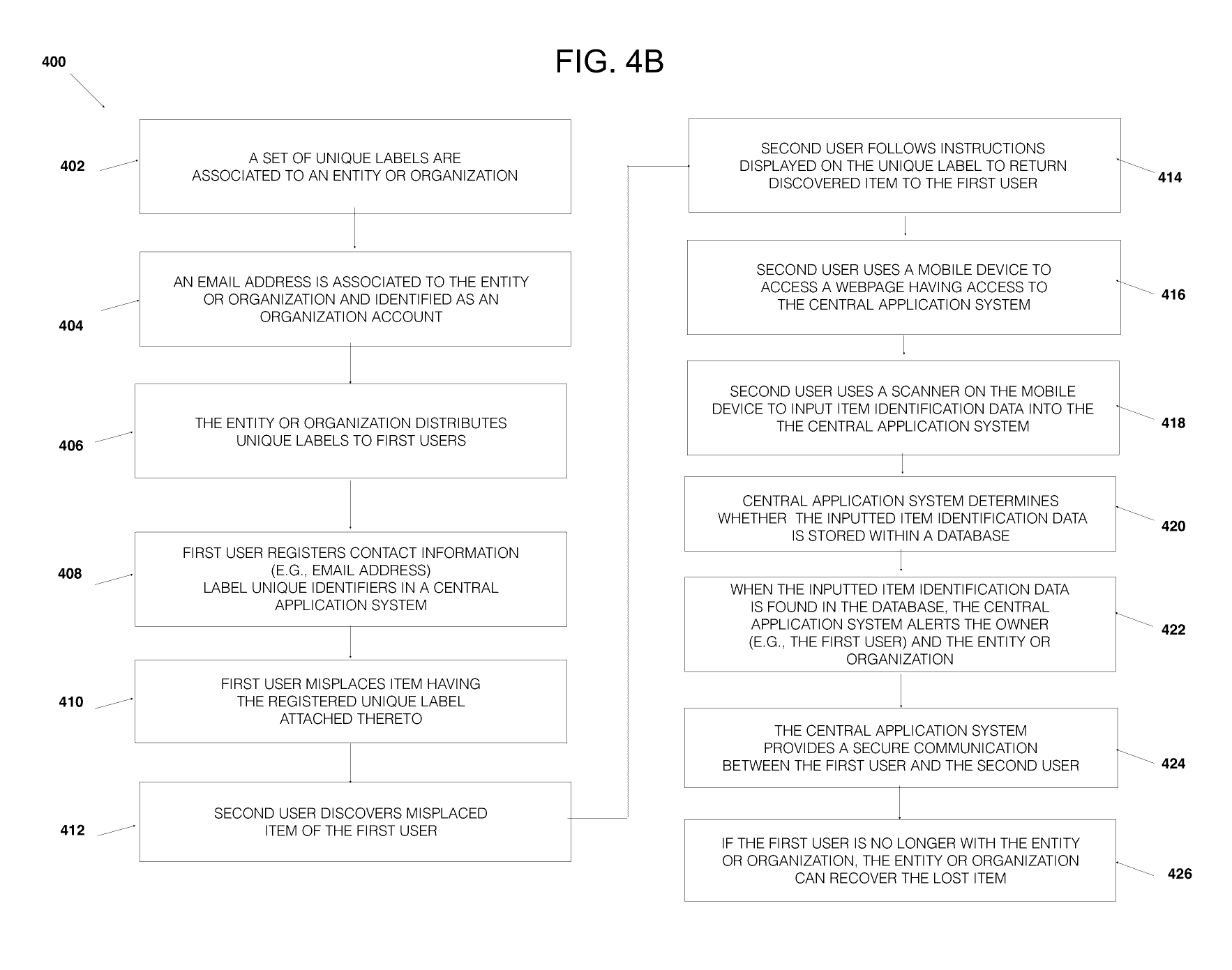

FIG. 4A illustrates a flow chart showing a method 300 for recovering lost items according to another example embodiment of the present general inventive concept.

The method 300 for recovering lost items according to the present example embodiment includes similar steps as described in the previous example embodiment. However, the method 300 for recovering lost items further includes using a communication module 130 to facilitate a secure communication between the owner of a lost item and the finder of that item. In addition, in the present example embodiment, the unique label 140 may be affixed to the item directly at the manufacturer and/or distributor of the item 16.

In alternative example embodiments, the unique label 140 may be included in the manufacturer's packaging of the item or product sold retail, wholesale, or online as a value add for people who purchase such items (e.g., a hammer sold at Home Depot may include a FindOwner unique label in the packaging). In addition, items sold online may include the FindOwner unique label 140 in their packaging and may charge the consumers an additional fee for the ability to participate in the virtual lost and found system according to the present general inventive concept.

At step 302, the first user 10 registers his contact information and the item identification data displayed on the unique label 140 with a central application system 110.

At step 304, the first user 10 misplaces or loses the item having the registered unique label 140 attached thereto.

At step 306, the second user 20 discovers the item belonging to the first user 10.

At step 308, the second user 20 follows instructions displayed on the unique label 140 in order to return the item to the first user 10.

At step 310, the second user 20 uses a mobile applications executed on a mobile device having a processor and a data storage device to access the central application system 110 over the Internet in the cloud.

At step 312, the second user 20 uses an image capturing device (e.g., scanner or camera) on the mobile device to scan and input the item identification data displayed on the unique label 140 of the found item into the central application system 110.

At step 314, the central application system 110 determines whether the item identification data inputted by the second user 20 is stored within the database 110a.

At step 316, when the central application system 110 determines that the item identification data inputted by the second user 20 is stored within the database 110a, the central application system alerts the registered owner corresponding to the inputted item identification data.

At step 318, the central application system 110 provides a means for allowing secure communication between the first user 10 and the second user 20 through the communication module 130 in order to coordinate the return of the item 16 to the first user 10.

FIG. 4B illustrates a flow chart 400 showing a method for recovering lost items according to another example embodiment of the present general inventive concept.

The method 400 for recovering lost items according to the present example embodiment includes similar steps as described in the previous example embodiments. However, the method 400 for recovering lost items further provides that a set of the unique labels 140 are associated with an entity or an organization. (Step 402). The method 400 further provides that contact information such as an email address is associated to the entity or organization and is then identified as an organization account. (Step 404). The method 400 further provides that the entity or organization distributes the unique labels 140 to first users (e.g., users of items) (Step 406).

Next, at step 408, the first user 10 registers his contact information and the item identification data displayed on the unique label 140 with a central application system 110.

At step 410, the first user 10 misplaces or loses the item having the registered unique label 140 attached thereto.

At step 412, the second user 20 discovers the lost item belonging to the first user 10.

At step 414, the second user 20 follows instructions displayed on the unique label 140 in order to return the item to the first user 10.

At step 416, the second user 20 uses an application on a mobile device having a processor and a data storage device to access the central application system 110 over the Internet in the cloud.

At step 418, the second user 20 uses an identification data capturing device (e.g., scanner, RFID scanner, NFC scanner, camera) on the mobile device to scan and input the item identification data displayed on the unique label 140 of the found item into the central application system 110.

At step 420, the central application system 110 determines whether the item identification data inputted by the second user 20 is stored within the database 110a.

At step 422, when the central application system 110 determines that the item identification data inputted by the second user 20 is stored within the database 110a, the central application system alerts both the first user and the organization corresponding to the inputted item identification data.

At step 424, the central application system 110 provides a means for allowing secure communication between the first user 10 and the second user 20 through the communication module 130 in order to coordinate the safe return of the item to the first user 10.

At step 426, if the first user is no longer with the entity or organization, the entity or organization may recover the lost item from the second user 20.

There are several other methods for locating a lost phone or other electronic device that has communication and/or location capabilities. As such, these methods are dependent on power supply of the lost devices. That is, if the lost device has no battery life and the second user is unable to charge or power up the item, then the item cannot be located by the first user. However, if the item has the unique label according to the present invention attached thereto, the second user may still notify the first user through a website or through a mobile application downloaded onto the second user's mobile device. However, the present general inventive concept is not limited thereto.

In further alternative example embodiments, the unique label may be embodied as a wristband, embedded or affixed within children's or elderly clothing and may be scanned by various methods including Bluetooth, RFID, NFC, or the like. On locating the lost person or child, the second user may input the unique identification data displayed on the unique label 140 into the central application system 110 and co-ordinate to re-unite the lost person with their family or caretaker.

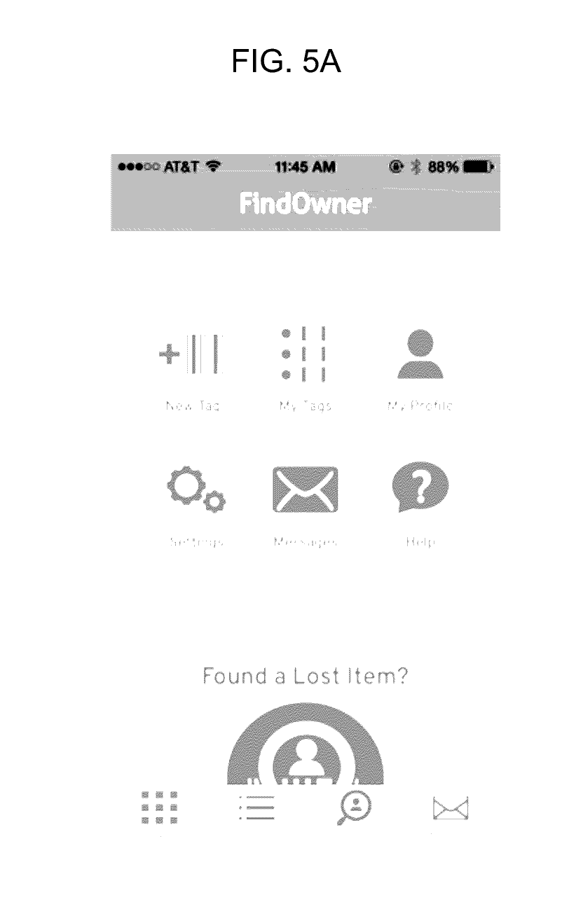

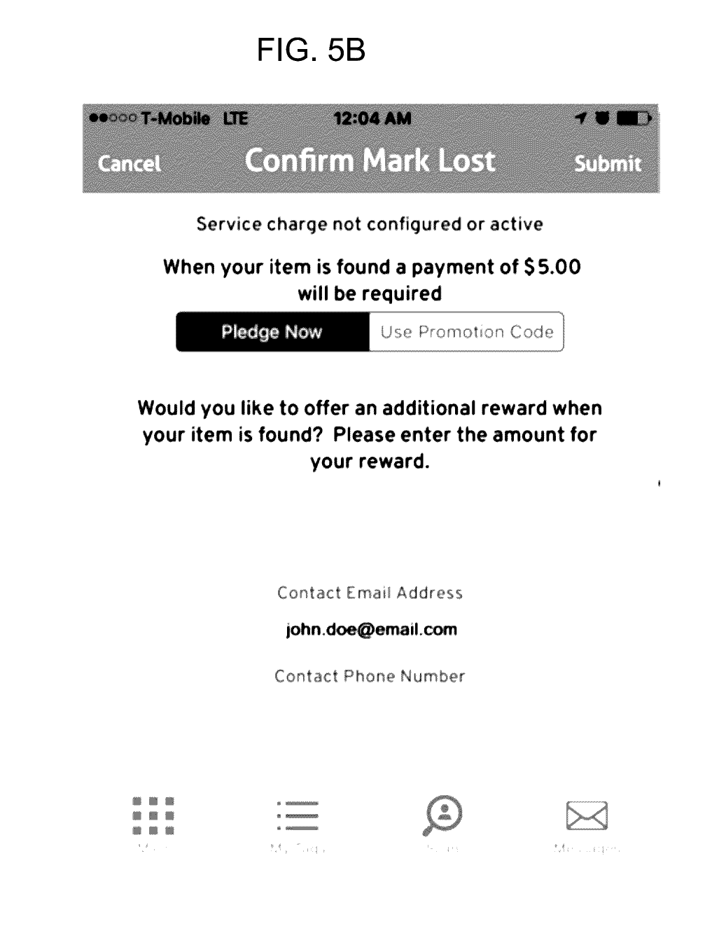

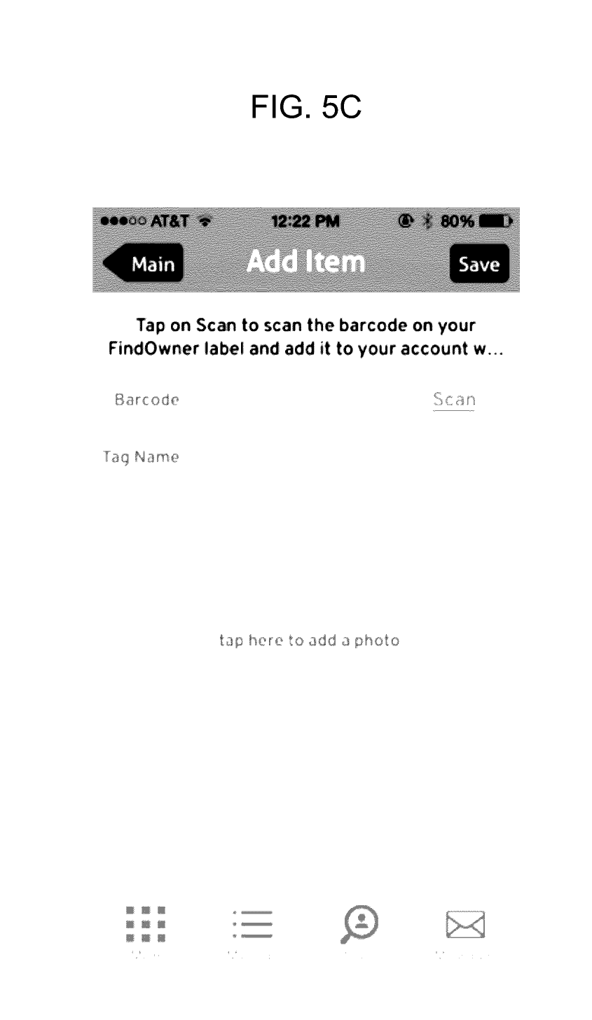

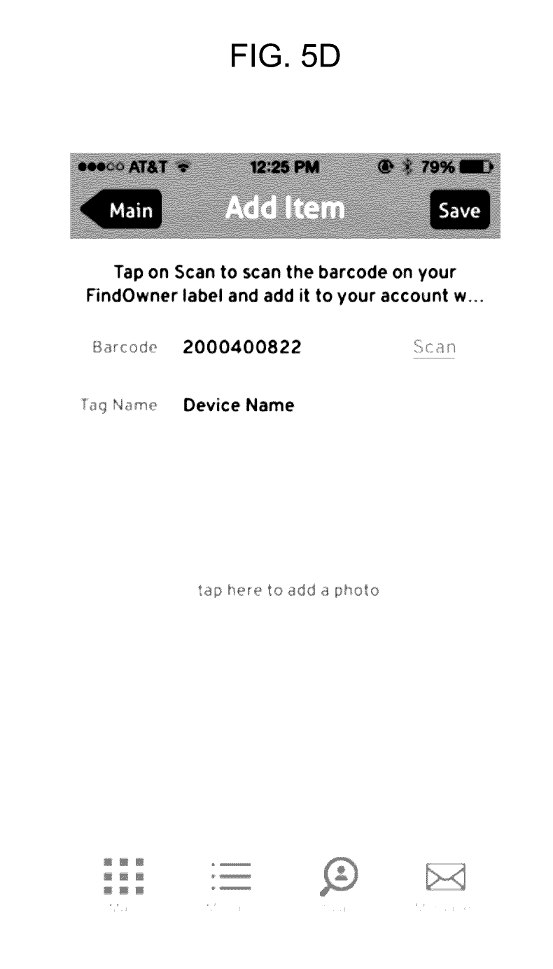

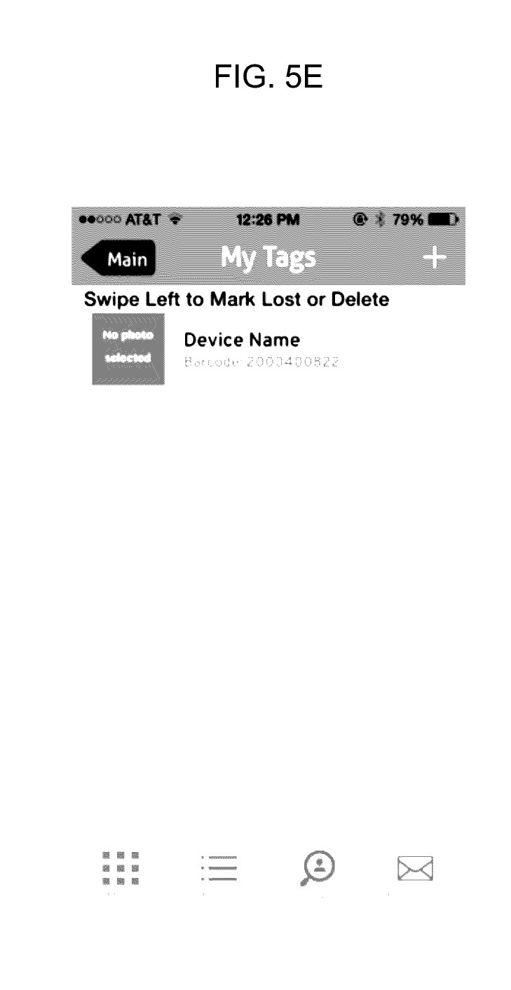

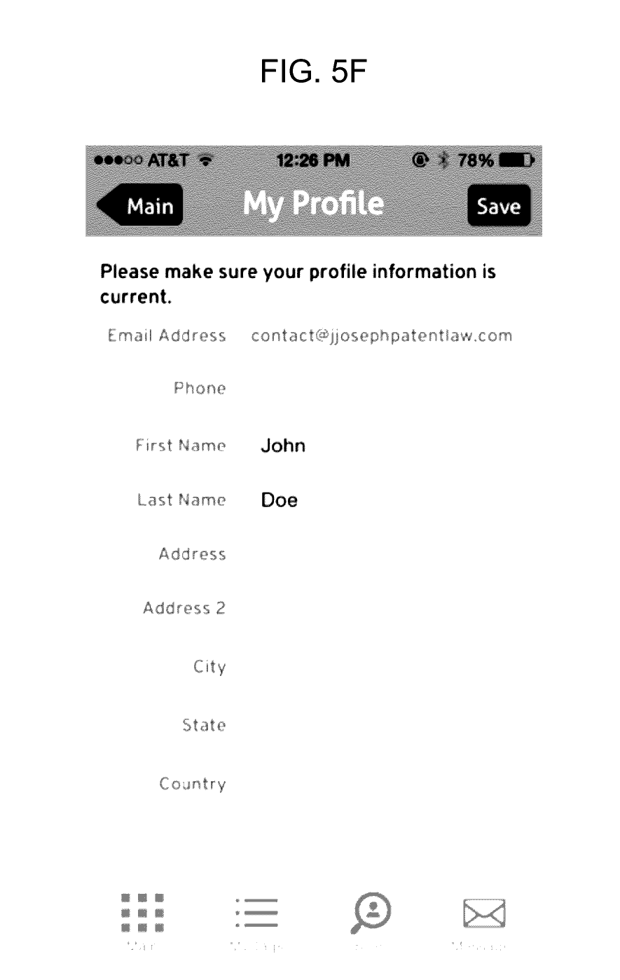

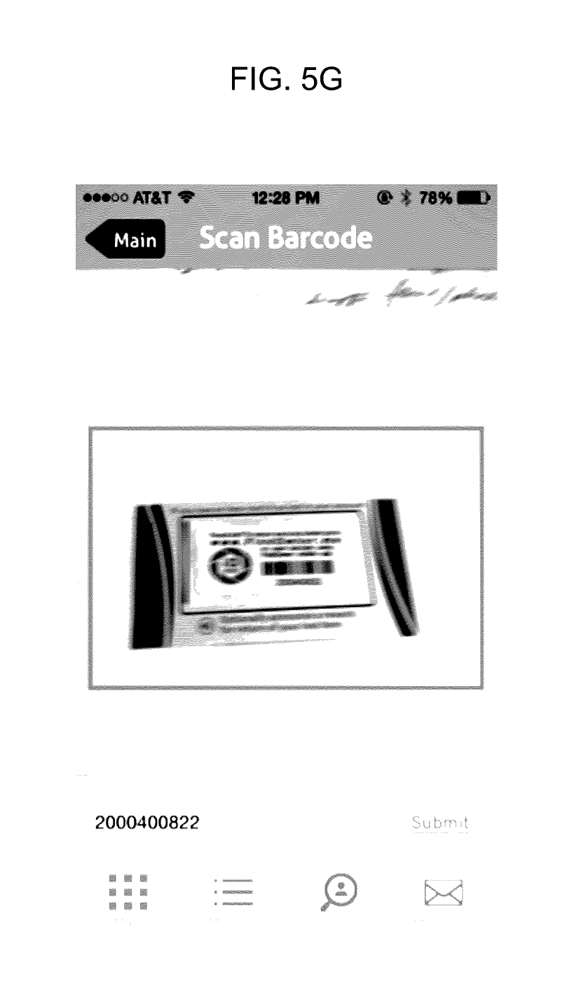

FIGS. 5A-5G illustrates graphical user interface (GUI) of a mobile application implementing a method for recovering lost items according to an example embodiment of the present general inventive concept.

FIG. 5A illustrates a dashboard of a main menu of the FindOwner mobile application. The dashboard may include selectable options which allows a user (e.g., a first user) to add a new unique label to his account; to view a listing of previously registered unique labels and corresponding items; to view the user profile information which may include user contact information and various other user preference information; to communicate with a finder of a lost item; and to request assistance from a third party.

FIG. 5B illustrates a screen which allows the first user to indicate that an item has been lost. The first user (i.e., owner) may pledge for the service fee amount, if any, or use a promotion code instead. The first user may also announce whether or not a reward will be provided or given to the finder of the lost item. The first user may further edit his or her contact information.

FIG. 5C illustrates a screen which allows the first user to register a FindOwner unique label by using a mobile device to scan a barcode on the unique barcode and providing a description of the item. In addition, the first user may use the mobile application to capture an image of the item associated with the unique label.

FIG. 5D illustrates an example item (i.e., Device Name) having a unique label number 200400822 being added to the first user's account.

FIG. 5E illustrates a screen showing a list of items registered in the first user account. User may tap on each item to view additional details.

FIG. 5F illustrates a first user profile screen.

FIG. 5G illustrates the mobile application scanning a bar code from a unique label.

The present general inventive concept creates a virtual and global lost and found department which may be accessible over the Internet via a web browser or a custom web application program executed on a mobile device. An owner of an item will be able to tag an item with a unique label which includes a serial number, a barcode, and a logo. The user may use a mobile device having a camera to capture a picture of the item, scan the barcode, and register the item in the user's account. The unique labels may include self adhesive patches to be able to attach to a plurality of devices.

Logging or registering the item in the user's account declares the ownership of the item. Multiple items may be added or logged into the user's account with a short description for each item. If an item is lost, the owner can access their account and mark it as a lost and looking.

Additionally, the owner may pledge a bonus reward for return of the lost item that may be given to the finder or split between the finder and a third party (e.g, FindOwner.me).

For instance, a random person happens to find a soccer ball after the player has left the field. He sees the FindOwner.me tag (i.e., unique label) and realizes that there is a mobile application to assist in returning the ball to the owner. If he doesn't have the application, he may download the application to his mobile phone and scans the barcode displayed on the unique label or tag.

If the unique label or tag is a bit messed up and the mobile phone camera is unable to scan the barcode, the owner can also type in the serial number below the barcode. If there is a match then a picture of the actual item may be displayed for the finder and an option to send a message (by text or email) to the owner. If there is a bonus reward for returning the lost item then that amount (finder's reward amount if it is to be shared with the finder and FindOwner.me) is also displayed.

Personal items wear-n-tear over time. Over time the portfolio value of the items logged on FindOwner.me will increase and be of significant value. Advertisement may be a revenue channel for the business. If a person owns sports items that are tagged and logged with labels, then related sports equipment advertisements are pushed to the end user.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A method of recovering a lost item belonging to a first user, the method comprising:
obtaining a unique label having item identification data displayed on a first surface and an adhesive layer on an opposing second surface:
affixing the unique label onto an item belonging to a first user;
registering an account by inputting first user identification information and the item identification data displayed on the unique label into a central application system; and
receiving an alert when item identification data inputted by a second user into the central application system matches the item identification data registered to the account corresponding to the first user.

2. The method of claim 1, wherein the unique label further includes item return instructions and return contact information.

3. The method of claim 1, wherein the item identification data includes a barcode or a QR code.

4. The method of claim 1, further comprising registering an account to a web site using the first user identification information.

5. The method of claim 1, wherein at least one of the first user identification information and the item identification data displayed on the unique label is inputted into the database using a first mobile device.

6. The method of claim 5, wherein the item identification data includes a barcode or a QR code corresponding to the item belonging to the first user.

7. The method of claim 6, wherein the first mobile device includes an image capturing device to read the barcode or the QR code of the item identification data.

8. The method of claim 7, further comprising using the first mobile device to capture an image of the item belonging to the first user and inputting the captured image to the database.

9. The method of claim 7, further comprising inputting into the database a reward for returning the item back to the first user.

10. The method of claim 6, wherein the second user inputs the item identification data displayed on the unique label into the database using a second mobile device, when the item is found by the second user.

11. The method of claim 1, wherein the unique labels may include tags, key chain tags, iron or labels for clothing, wristbands, or suitcase tags.
